(19) United States
(12) Patent Application Publication
(10) Pub. No.: US 2018/0315039 A1
(43) Pub. Date: Nov. 1, 2018

(54) INFORMATION PROCESSING APPARATUS, MONEY PAYMENT METHOD, AND COMPUTER PROGRAM

(71) Applicant: NOMURA RESEARCH INSTITUTE, LTD., Tokyo (JP)

(72) Inventor: Hirotaka TOGASHI, Tokyo (JP)

(73) Assignee: NOMURA RESEARCH INSTITUTE, LTD., Tokyo (JP)

(21) Appl. No.: 16/026,724

(22) Filed: Jul. 3, 2018

Related U.S. Application Data
(63) Continuation of application No. PCT/JP2016/050033, filed on Jan. 4, 2016.

(51) Int. Cl. G06Q 20/34; G06Q 20/10

(52) U.S. Cl. CPC G06Q 20/341; G06Q 20/1085

(57) ABSTRACT

A remuneration payment GW acquires payment information indicating a payee ID indicating a payee of money and a payment amount of the money from first and second company business devices. Further, the remuneration payment GW acquires, from an ATM, personal data read by the ATM from a medium on which a personal number given to an individual by an administrative agency. In the case where an ID specified on the basis of the personal data acquired from the ATM accords with the payee ID indicated by the payment information, the remuneration payment GW executes processing for paying the payment amount indicated by the payment information to the individual from at least one of a bank account of a first company and a bank account of a second company.

### BACKGROUND

### Technical Field

The present invention relates to a data processing technology, and in particular to a technology of supporting payment of money from a company to an individual.

### Related Art

A personal number (My Number (registered trademark)) is planned to be given to each citizen from October 2015. The personal number is composed of 12-digit number, and is in principle a personal ID unchanged for a lifetime. In addition, from 2016, the personal number will be required for administrative procedures such as social security, tax, disaster countermeasures, and the like (see, for example, JP 2015-79406 A). In the future, companies will need to acquire the personal number of an individual who will be a payee of money and set the personal number in a legal record concerning payment to be submitted to an administrative agency.

### SUMMARY

By the way, an individual who is given a personal number from an administrative agency can acquire a personal number card in which information such as his/her personal number is recorded on an IC chip. The present inventor has thought that realization of an efficient money payment process corresponding to the number system can be supported by use of the personal number card owned by the individual.

To solve the above problem, an information processing apparatus according to a certain aspect of the present invention is an information processing apparatus connected with an information terminal operated by an individual and a company to pay money to the individual via a communication network, the information processing apparatus including a payment information acquisition unit configured to acquire, from the company, payment information indicating a payee ID indicating a payee of money and a payment amount of the money, a personal data acquisition unit configured to acquire, from the information terminal, personal data read by the information terminal from a medium on which a personal number given to the individual by a public agency is recorded, and a money payment unit configured to execute processing for paying the payment amount indicated by the payment information to the individual from an account opened in a financial institution by the company in a case where an ID specified on the basis of the personal data acquired from the information terminal accords with the payee ID indicated by the payment information.

Another aspect of the present invention is a money payment method. In this method, an information processing apparatus connected with an information terminal operated by an individual and a company to pay money to the individual via a communication network executes the steps of acquiring, from the company, payment information indicating a payee ID indicating a payee of money and a payment amount of the money, acquiring, from the information terminal, personal data read by the information terminal from a medium on which a personal number given to the individual by a public agency is recorded, and executing processing for paying the payment amount indicated by the payment information to the individual from an account opened in a financial institution by the company in a case where an ID specified on the basis of the personal data acquired from the information terminal accords with the payee ID indicated by the payment information.

Note that an arbitrary combination of the above constituent elements and expression of the present invention converted between a system, a computer program, a recording medium storing a computer program, and the like are also effective as aspects of the present invention.

According to the present invention, realization of an efficient money payment process corresponding to the number system can be supported by use of a personal number card owned by an individual.

### BRIEF DESCRIPTION OF DRAWINGS

FIG. 1 is a diagram illustrating a configuration of a remuneration payment system according to an embodiment;

FIG. 2 is a block diagram illustrating a functional configuration of an ATM in FIG. 1;

FIG. 3 is a block diagram illustrating a functional configuration of a remuneration payment GW in FIG. 1;

FIG. 4 is a diagram illustrating an example of personal attribute information held in a personal attribute holding unit;

FIG. 5 is a sequence diagram illustrating an operation of the remuneration payment system;

FIG. 6 is a sequence diagram illustrating an operation of the remuneration payment system;

FIG. 7 is a sequence diagram illustrating an operation of the remuneration payment system; and

FIG. 8 is a diagram illustrating an example of statement management information held in the personal attribute holding unit.

### DETAILED DESCRIPTION

First, an outline will be described. The present inventor has considered that there are the following problems regarding money payment from companies to individuals. (1) In a company having a large number of individuals to whom remuneration, fee, and the like are to be paid, considerable costs are required for management of payees, management of payment statements, transfer to individual accounts, and the like. (2) From 2016, companies are required to accept the personal numbers of individuals in money payment, and a large cost is expected for identity verification and security control measures based on the numbering law. (3) On the other hand, individuals who receive money payment, such as professionals, may receive money payment from several companies, costs for managing whether remuneration and fee have appropriately paid, in other words, whether unreceived remuneration and the like occur are required.

To solve such problems, a remuneration payment system proposed in an embodiment has the following characteristics. (1) Each company prepares its checking account and collectively pools a payment scheduled money to a plurality of individuals in its checking account. (2) A virtual account on an individual basis is created from a payment schedule statement separately prepared from the checking account of each company. At this time, to aggregate payment statements of a plurality of companies on an individual basis, a serial number of an electronic certificate included in the personal number card is used. (3) An individual who will receive money inquires his/her own virtual account through an ATM or a PC on the assumption that the individual performs identify verification using the electronic certificate of the personal number card, and can confirm payment relationship with each of the plurality of companies and withdrawal of money to be paid from the plurality of companies.

According to the remuneration payment system of the embodiment, the following effects are exhibited, for example. (1) An individual who will receive remuneration can receive the remuneration and fee from a company, using the personal number card without opening his/her own bank account. In other words, the company who will pay remuneration does not need to manage information of bank accounts of a plurality of individuals who are remuneration payees. Note that, in the embodiment, the personal number card is used. However, the technology described in the embodiment can be applied to a system that receives money using various media on which an ID (a social security number or the like) corresponding to the personal number given to the individual from a public agency is recorded.

Further, (2) an individual who will receive remuneration can instantly use the service by only presenting the personal number card. For example, registration of four basic information and the like by manual input when joining a service is not necessary. (3) An individual who will receive remuneration can easily grasp the payment relationship with a plurality of companies. (4) An individual who will receive remuneration can perform log-in without transmitting personal information when logging in to a service in the second time onward and can use the service. (5) A company who will pay remuneration can decrease the cost for management of remuneration payees and procedures of remuneration payment (bank transfer and the like). (6) A company who will pay remuneration can minimize handling of the personal numbers and can decrease the risk of leakage and the like. Hereinafter, the remuneration payment system of the embodiment will be described in detail.

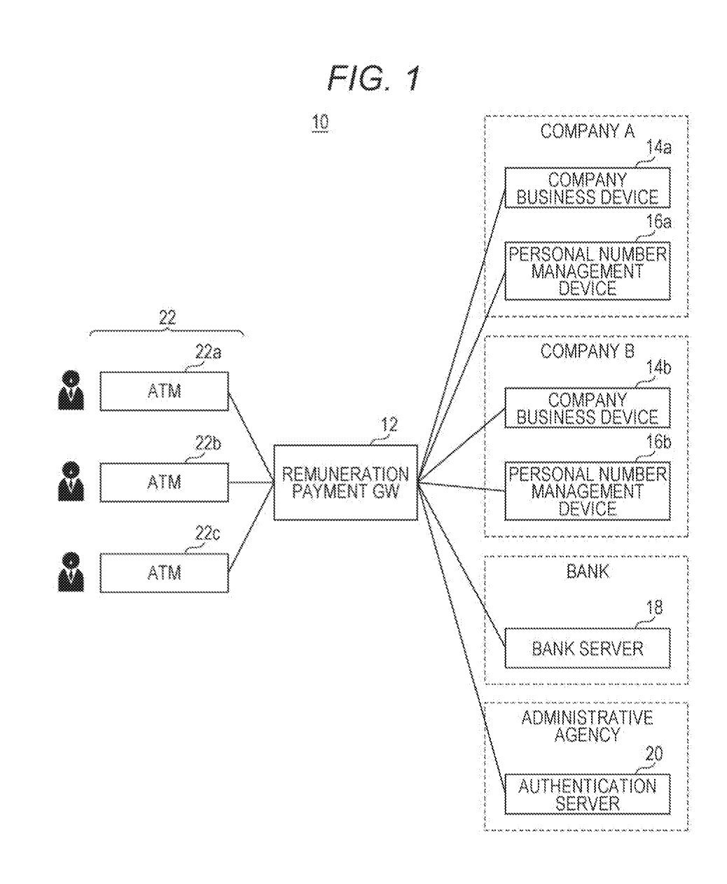

FIG. 1 illustrates a configuration of a remuneration payment system 10 according to an embodiment. The remuneration payment system 10 includes a remuneration payment gate way (GW) 12, a company business device 14a, a company business device 14b, a personal number management device 16a, a personal number management device 16b, a bank server 18, an authentication server 20, and an ATM 22a, an ATM 22b, and an ATM 22c (collectively referred to as ATM 22). These devices are connected via a known communication network including a LAN, a WAN, the Internet, and a dedicated line network.

The company business device 14a and the company business device 14b are information processing apparatuses installed in companies that provide resources for remuneration to be paid to individuals, and support various types of business such as accounting. The personal number management device 16a and the personal number management device 16b are information processing apparatuses that manage personal numbers of individuals who are remuneration payees.

In the embodiment, the company business device 14a and the personal number management device 16a are devices managed by a company A, and the company business device 14b and the personal number management device 16b are devices managed by a company B. That is, an owning entity of the personal number notified from an individual is a company. At least one of the company A and the company B may use a personal number management service provided by an application service provider (ASP) operator, and in that case, at least one of the personal number management device 16a and the personal number management device 16b may be physically provided in the ASP operator.

The bank server 18 is an information processing apparatus of a bank in which the company A and the company B have opened checking accounts. The checking account of each company serves as a money pool in which money to be paid by the company as remuneration to a plurality of individuals is collectively deposited. The company A and the company B may open the checking accounts in different banks, that is, the remuneration payment system 10 may include a plurality of the bank servers 18 of a plurality of banks. As will be described below, the bank server 18 executes reply processing to a balance inquiry of the checking account and withdrawal control of the ATM 22.

The authentication server 20 is an information processing apparatus managed by an administrative agency or a private enterprise entrusted by the administrative agency and provides a public personal authentication service using a personal number card. The authentication server 20 holds a revocation list of the personal number, and executes processing of confirming validity of electronic certificates (an electronic certificate for signature and an electronic certificate for user certification) stored in the personal number card on the basis of a request from the remuneration payment GW 12.

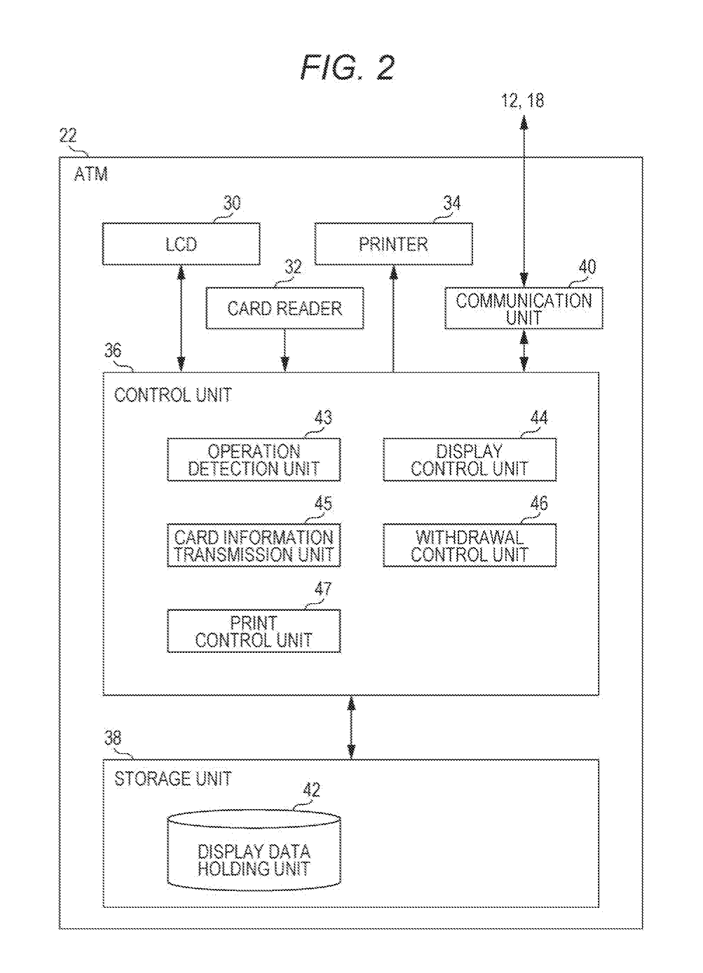

The ATM 22 is an information terminal operated by the individual who is the remuneration payee (hereinafter also referred to as “user”), and provides an interface function with the user such as display of various messages and reading of information input by the user. For example, the ATM 22 is installed in a bank store or a convenience store. A detailed configuration of the ATM 22 will be described below with reference to FIG. 2.

The remuneration payment GW 12 is an information processing apparatus that supports creation of remuneration payment from a company to an individual and creation of a payment record. The remuneration payment GW 12 is connected with a plurality of the ATMs 22, a plurality of company devices (the company business device 14a, the company business device 14b, the personal number management device 16a, and the personal number management device 16b), a plurality of the bank servers 18, and the authentication server 20, and can also be said to be a gate way device that relays electronic data.

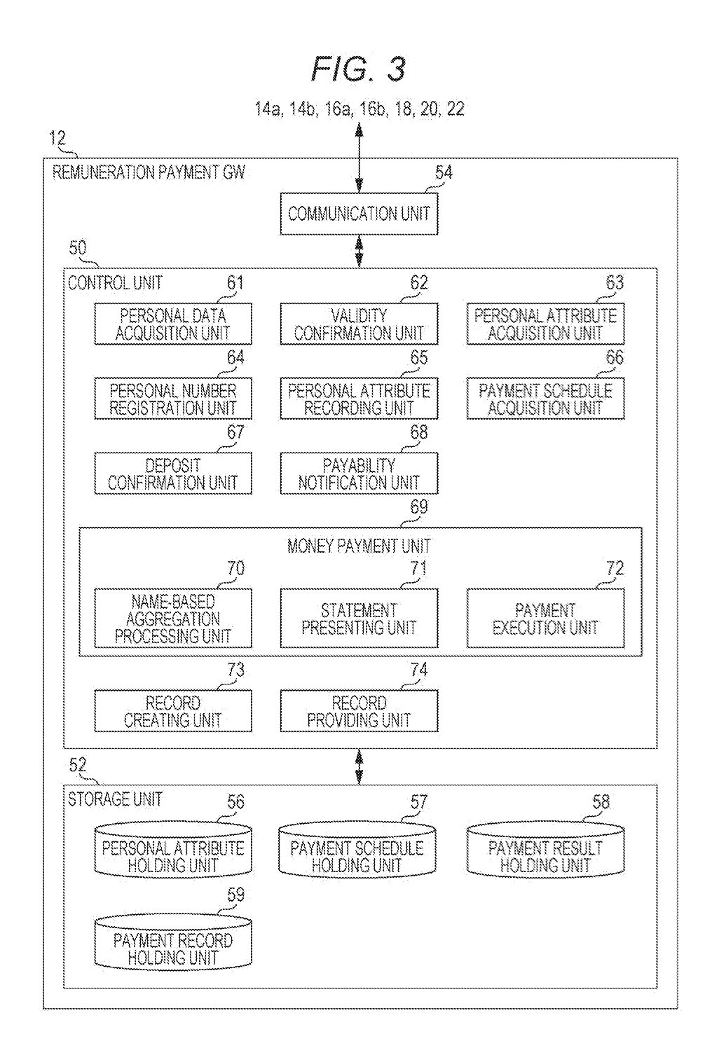

An outline of processing by the remuneration payment GW 12 will be described. The remuneration payment GW 12 acquires the payment information indicating a payee ID indicating a payee of money and a payment amount of the money from the company business device 14a and the company business device 14b. The remuneration payment GW 12 acquires personal data read from the personal number card by the ATM 22. In the case where an ID specified on the basis of the personal data acquired from the ATM 22 accords with the payee ID indicated by the payment information received from the company A, the remuneration payment GW 12 executes processing for paying the payment amount indicated by the payment information to the individual from the checking account of the company A. Further, in the case where an ID specified on the basis of the personal data acquired from the ATM 22 accords with the payee ID indicated by the payment information received from the company B, the remuneration payment GW 12 executes processing for paying the payment amount indicated by the payment information to the individual from the checking account of the company B. A detailed configuration of the remuneration payment GW 12 will be described below with reference to FIG. 3.

FIG. 2 is a block diagram illustrating a functional configuration of the ATM 22 in FIG. 1. The ATM 22 includes an LCD 30, a card reader 32, a printer 34, a control unit 36, a storage unit 38, and a communication unit 40.

Each block illustrated in the block diagram of the present specification can be realized by an element such as a CPU of a computer and a mechanical device in terms of hardware and can be realized by a computer program or the like in terms of software. Here, functional blocks realized by cooperation of the hardware and software are drawn. Therefore, those skilled in the art will understand that these functional blocks can be realized in various forms by a combination of the hardware and software.

The LCD 30 is a liquid crystal display mounted on a casing of the ATM 22, and displays various electronic contents. The LCD 30 also has a touch panel function and also functions as information input means. The card reader 32 reads data from an IC card or a magnetic stripe card such as a cash card or a personal number card. The printer 34 prints data to be printed output from the control unit 36 on a roll paper or the like, and prints a receipt, for example.

The control unit 36 executes data processing regarding financial transactions, and executes data processing regarding remuneration reception, typically, user interface control in the embodiment. The storage unit 38 is a storage area for storing data to be referred to and updated by the control unit 36. The communication unit 40 performs communicate with an external device according to a predetermined communication protocol. The control unit 36 transmits and receives data to and from the remuneration payment GW 12 and the bank server 18 via the communication unit 40.

The storage unit 38 includes a display data holding unit 42. The display data holding unit 42 holds the electronic contents to be displayed and presented to the user by the LCD 30. Note that the electronic contents to be presented to the user may be held in the remuneration payment GW 12 and may be provided from the remuneration payment GW 12 to the ATM 22 as needed. Further, both the ATM 22 and the remuneration payment GW 12 may hold a plurality of display contents in a dispersed manner.

The control unit 36 includes an operation detection unit 43, a display control unit 44, a card information transmission unit 45, a withdrawal control unit 46, and a print control unit 47.

The operation detection unit 43 detects an operation input by the user to the LCD 30, and notifies information indicating operation content to other function blocks. The display control unit 44 controls screen display of the LCD 30. For example, the display control unit 44 causes the LCD 30 to display the content held in the display data holding unit 42 and switches the content to be displayed by the LCD 30, according to a user operation detected by the operation detection unit 43.

The card information transmission unit 45 transmits data of the personal number card read by the card reader 32 to the remuneration payment GW 12. The withdrawal control unit 46 controls withdrawal of money from the ATM 22 and provides the money to the user. The print control unit 47 controls print processing of the printer 34, and outputs data to be printed to the printer 34 and causes the printer 34 to print the data on a roll paper or the like.

FIG. 3 is a block diagram illustrating a functional configuration of the remuneration payment GW 12 in FIG. 1. The remuneration payment GW 12 includes a control unit 50, a storage unit 52, and a communication unit 54.

The control unit 50 executes data processing for supporting payment of money from a company to an individual. The storage unit 52 is a storage area for storing various data to be referred to and updated by the control unit 50. The communication unit 54 performs communicate with an external device according to a predetermined communication protocol. The control unit 50 transmits and receives data to and from the company business device 14a, the company business device 14b, the personal number management device 16a, the personal number management device 16b, the bank server 18, the authentication server 20, and the ATM 22 via the communication unit 54.

For example, a computer program including a plurality of modules corresponding to a plurality of functional blocks in the control unit 50 may be stored in the storage medium such as a DVD and installed in a storage of the remuneration payment GW 12. A CPU of the remuneration payment GW 12 may exhibit a function of each functional block by reading the computer program stored in a storage to a main memory and executing the computer program. The storage unit 52 may be realized by storing data by the storage or the memory of the remuneration payment GW 12.

The storage unit 52 includes a personal attribute holding unit 56, a payment schedule holding unit 57, a payment result holding unit 58, and a payment record holding unit 59.

The personal attribute holding unit 56 holds attribute information regarding the individual who is the remuneration payee (hereinafter the attribute information is also referred to as “personal attribute information”). The personal attribute holding unit 56 holds a plurality of pieces of the personal attribute information corresponding to a plurality of individuals who have performed user registration of a remuneration payment service.

The personal attribute information includes ID information in which a personal ID specified on the basis of personal data read from a personal number card of a certain individual by the ATM 22 is associated with a company A payee ID and a company B payee ID. The company A payee ID is an ID for identifying the individual uniquely determined by the company A, and the company B payee ID is an ID for identifying the individual uniquely determined by the company B. The ID information of the personal attribute information can be said to be information indicating correspondence relationship among a plurality of types of IDs in different systems.

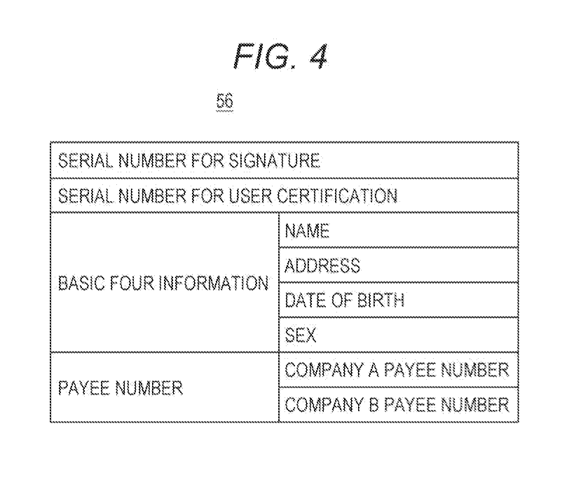

FIG. 4 illustrates an example of the personal attribute information held in the personal attribute holding unit 56. The personal attribute information includes a serial number for signature and a serial number for user certification as the personal IDs, a company A payee number as the company A payee ID, and a company B payee number as the company B payee ID. Furthermore, the personal attribute information includes a name, an address, a date of birth, and an address, which are called four basic information of the individual. The personal attribute holding unit 56 holds the personal attribute information having the configuration illustrated in FIG. 4 for each individual who has performed user registration via the ATM 22. Although not illustrated in FIG. 4, the personal attribute information further includes contact information (an e-mail address and the like) of each individual. However, the personal attribute information does not include the personal number of the individual who is the remuneration payee.

Returning to FIG. 3, the payment schedule holding unit 57 holds payment schedule statements as payment information received from the company business device 14a (company A) and the company business device 14b (company B). The payment schedule statement is document data in which the company A payee number or the company B payee number indicating the payee of money is associated with a payment scheduled amount of money. The payment result holding unit 58 holds a payment result statement (can also be said to be paid statement) corresponding to the payment schedule statement. The payment result statement is document data in which the company A payee number or the company B payee number indicating the payee of money is associated with a paid amount of money.

The payment record holding unit 59 holds data of a payment record that is a legal record in which facts regarding money payment is written and to be submitted to a public agency such as a tax office. The data of a payment record includes date and time of payment (when), information of a payer company (who), information of the payee individual (to whom), and the payment amount (how much paid). Note that the payment record data held in the payment record holding unit 59 does not include the personal number of the payee individual.

The control unit 50 includes a personal data acquisition unit 61, a validity confirmation unit 62, a personal attribute acquisition unit 63, a personal number registration unit 64, a personal attribute recording unit 65, a payment schedule acquisition unit 66, a deposit confirmation unit 67, a payability notification unit 68, a money payment unit 69, a record creating unit 73, and a record providing unit 74.

The personal data acquisition unit 61 acquires, from the ATM 22, the personal data that is data read from the personal number card by the ATM 22. The personal data in the embodiment is an electronic certificate for signature or an electronic certificate for user certification.

The validity confirmation unit 62 confirms validity of the electronic certificate for signature and the electronic certificate for user certification acquired by the personal data acquisition unit 61 in cooperation with the authentication server 20. This validity confirmation processing may be realized by a known method. For example, the validity confirmation unit 62 may transmit data of the electronic certificate for signature or the electronic certificate for user certification acquired by the personal data acquisition unit 61 to the authentication server 20, and receive information indicating whether the electronic certificate is valid from the authentication server 20.

The personal attribute acquisition unit 63 opens the electronic certificate for signature acquired by the personal data acquisition unit 61 by a known method, and extracts the attribute information of the individual from the electronic certificate for signature. Specifically, the personal attribute acquisition unit 63 acquires the four basic information, the personal number, and the serial number for signature as the attribute information of the individual. Further, the personal attribute acquisition unit 63 opens the electronic certificate for user certification acquired by the personal data acquisition unit 61 by a known method, and extracts the attribute information of the individual from the electronic certificate for user certification. Specifically, the personal attribute acquisition unit 63 acquires the serial number for user certification as the attribute information of the individual.

Further, the personal attribute acquisition unit 63 acquires the serial number for user certification of the individual on the basis of the serial number for signature of the individual from the authentication server 20 by a known method. For example, an API for serial number for user certification acquisition provided in the authentication server 20 may be called using the serial number for signature as an argument. Then, in the public agency, the serial number for user certification associated in advance with the serial number for signature may be acquired as a return value.

The personal number registration unit 64 transmits the personal number of the individual acquired by the personal attribute acquisition unit 63 to the personal number management device 16a and the personal number management device 16b and registers the personal number. In the case where the individual specifies only one of the company A and the company B as a report destination of the personal number at the ATM 22, the personal number registration unit 64 may register the personal number only to the device of the specified reporting company. The personal number management device 16a and the personal number management device 16b may confirm correctness of the personal attribute information. In this case, the personal number registration unit 64 may further transmit information necessary for correctness confirmation, such as the name and the address, which is another personal attribute information acquired by the personal attribute acquisition unit 63, to the personal number management device 16a and the personal number management device 16b.

When the personal number management device 16a (personal number management device 16b) of the embodiment receives registration of a personal number of a certain individual, the personal number management device 16a (personal number management device 16b) assigns the company A payee number (company B payee number) that is an ID unique to the company A (company B) for identifying the individual by the company A (company B). Then, the company A payee number (company B payee number) and the personal number are associated and stored. When the personal number registration unit 64 has registered the personal number to the personal number management device 16a (personal number management device 16b), the personal number registration unit 64 acquires the company A payee number (company B payee number) assigned in response to the registration from the personal number management device 16a (personal number management device 16b). Hereinafter, when collectively referring to the company A payee number and the company B payee number, they are called “payee number”.

The personal attribute recording unit 65 functions as an ID recording unit. The information processing apparatus according to claim personal attribute recording unit 65 stores, for an individual to be registered as a user, personal attribute information in which the four basic information, the serial number for signature, and the serial number for user certification acquired by the personal attribute acquisition unit 63 and the payee number acquired by the personal number registration unit 64 are associated with one another to the personal attribute holding unit 56. Note that the individual inputs its own contact information (for example, an e-main address) to the ATM 22, and the personal attribute recording unit 65 also stores the contact information of the individual to the personal attribute holding unit 56.

The payment schedule acquisition unit 66 functions as a payment information acquisition unit. The payment schedule acquisition unit 66 acquires the company A payee number and data of the payment schedule statement indicating the payment amount of money from the company business device 14a, and stores the data to the payment schedule holding unit 57 as a company A payment schedule statement. Further, the payment schedule acquisition unit 66 acquires the company B payee number and data of the payment schedule statement indicating the payment amount of money from the company business device 14b, and stores the data to the payment schedule holding unit 57 as a company B payment schedule statement.

The deposit confirmation unit 67 calculates the total amount of payment from the company A to the individual by reference to one or more company A payment schedule statements held in the payment schedule holding unit 57. The deposit confirmation unit 67 accesses the bank server 18 and confirms the balance of the checking account of the company A (hereinafter called “company A account”). When the balance of the company A account is the total amount of payment or more, deposited is determined and a deposited flag is set to each of the company A payment schedule statements. Similarly, the deposit confirmation unit 67 calculates the total amount of payment from the company B to the individual by reference to one or more company B payment schedule statements held in the payment schedule holding unit 57. The deposit confirmation unit 67 accesses the bank server 18 and confirms the balance of the checking account of the company B (hereinafter called “company B account”). When the balance of the company B account is the total amount of payment of the company B or more, deposited is determined and a deposited flag is set to each of the company B payment schedule statements.

Note that a payment date, for example, a date when remuneration is payable may be set to the payment schedule statement. The deposit confirmation unit 67 may calculates the total amount of payment of the company A by reference to the company A payment schedule statement that reaches the payment date, and execute the above-described processing. Similarly, the deposit confirmation unit 67 may calculates the total amount of payment of the company B by reference to the company B payment schedule statement that reaches the payment date, and execute the above-described processing.

The payability notification unit 68 notifies payability of the remuneration (reception of remuneration being possible) to the individual. Specifically, the payability notification unit 68 specifies the contact address of the individual associated with the company A payee number or the company B payee number indicated by the payment schedule statement to which a deposited flag is set by reference to the personal attribute information in the personal attribute holding unit 56. Then, the payability notification unit 68 transmits a message notifying that the reception of remuneration is possible to the contact address of the specified individual. For example, the payability notification unit 68 transmits an e-mail addressed to the e-mail address registered by the individual as the contact address. Note that, in the case where the payment date is set to the payment schedule statement, the payment schedule statement to which the deposited flag is set and having reached the payment date is notified.

In the case where the ID specified on the basis of the personal data acquired from the ATM 22 accords with the payee ID indicated by the payment schedule statement, the money payment unit 69 executes the processing for paying the payment amount indicated by the payment schedule statement to the individual from the checking account set in advance by the company. The money payment unit 69 includes a name-based aggregation processing unit 70, a statement presenting unit 71, and a payment execution unit 72, and executes the above-described processing by cooperation of the aforementioned units.

The name-based aggregation processing unit 70 identifies the company A payee number and the company B payee number associated in advance with the serial number for user certification acquired from the ATM 22 by reference to the personal attribute information of the personal attribute holding unit 56. The name-based aggregation processing unit 70 identifies one or more payment schedule statements with the company A payee number, of the payment schedule statements of the company A stored in the payment schedule holding unit 57, as the company A payment schedule statement. Further, the name-based aggregation processing unit 70 identifies one or more payment schedule statements with the company B payee number, of the payment schedule statements of the company B stored in the payment schedule holding unit 57, as the company B payment schedule statement.

The name-based aggregation processing unit 70 identifies the payment amount described in the one or more company A payment schedule statements to which a payability flag has been set, as a current payability amount to the user at the ATM 22 from the company A. On the other hand, the name-based aggregation processing unit 70 identifies the payment amount described in the one or more company A payment schedule statements to which the payability flag is not set, as a future payment scheduled amount to the user at the ATM 22 from the company A. Similarly, the name-based aggregation processing unit 70 identifies the payment amount described in the one or more company B payment schedule statements to which the payability flag is has been set, as a current payability amount to the user at the ATM 22 from the company B. On the other hand, the name-based aggregation processing unit 70 identifies the payment amount described in the one or more company B payment schedule statements to which the payability flag is not set, as a future payment scheduled amount to the user at the ATM 22 from the company B.

The statement presenting unit 71 transmits data of at least one of a payability statement that is a statement indicating the current payability amounts of the company A and the company B, and a payment schedule statement that is a statement indicating the future payment scheduled amounts of the company A and the company B to the ATM 22 and causes the ATM 22 to display the transmitted data. The ATM 22 may present the payability statement or the payment schedule statement according to a statement type selected by the individual, or may present both the payability statement and the payment schedule statement. Note that, as the current payability amount and the future payment scheduled amount, an aggregate result on an individual basis may be presented, an aggregate result on a company basis may be presented, or an individual payment schedule statement may be presented.

In the case where the individual requests the remuneration payment (cash withdrawal) at the ATM 22 on which the payability statement is displayed, the payment execution unit 72 transmits a cash withdrawal request that is data requesting cash withdrawal from at least one of the checking account of the company A and the checking account of the company B to the bank server 18. For example, in the case where the payability statement indicates a payable amount from the company A, the payment execution unit 72 may transmit, to the bank server 18, the cash withdrawal request to which an account number and a withdrawal amount (current payability amount) of the company A are set, in a format receivable online by the bank server 18. The bank server 18, which has received the cash withdrawal request, may transmit, to the ATM 22, data instructing withdrawal of the amount specified in the request from the ATM 22.

Further, in the case where the payment execution unit 72 has performed money payment processing to the individual, for example, in the case where the payment execution unit 72 has transmitted the cash withdrawal request to the bank server 18, the payment execution unit 72 generates data of the payment result statement and stores the data to the payment result holding unit 58. For example, the payment execution unit 72 may extract information of the payment amount and the payer company from the payment schedule statement and set the information to the payment result statement, extract information of the payee individual from the personal attribute information in the personal attribute holding unit 56 (without including the personal number) and set the information to the payment result statement, and further set the date and time of payment to the payment result statement.

The record creating unit 73 generates data of a payment record and stores the data to the payment record holding unit 59. The generation timing of the payment record may be when the time has reached a predetermined date and time from the year end to March or when a record creation instruction input by an administrator of the remuneration payment GW 12 has been received. The record creating unit 73 aggregates the payment result statement stored in the payment result holding unit 58 on a payer company basis and on a payee individual basis, and creates the payment record indicating when, from whom to whom, and how much money has been paid. The personal number is not included in the payment record created by the record creating unit 73. The record creating unit 73 stores the created payment record data in association with the serial number for user certification of the individual and the company A payee number or the company B payee number by company to the payment record holding unit 59.

The record providing unit 74 transmits the payment record data of the company A held in the payment record holding unit 59 together with the company A payee number to the personal number management device 16a. Similarly, the record providing unit 74 transmits the payment record data of the company B held in the payment record holding unit 59 together with the company B payee number to the personal number management device 16b. The transmission timing may be when the time has reached a predetermined date and time from the year end to March, when a record provision instruction input by the administrator of the remuneration payment GW 12 has been received, or when new payment record data has been stored to the payment record holding unit 59.

The record providing unit 74 transmits the payment record data to the personal number management device 16a and the personal number management device 16b, and causes the personal number management device 16a and the personal number management device 16b to execute processing of setting the personal number of the remuneration payee individual to the payment record data. The personal number management device 16a and the personal number management device 16b identify the personal number held in advance on the basis of a payee number received together with the payment record, and additionally set the personal number to the payment record. Further, in the case where the individual inputs an operation to request provision of the payment record at the ATM 22, the record providing unit 74 transmits the payment record data of the individual held in the payment record holding unit 59 to the ATM 22.

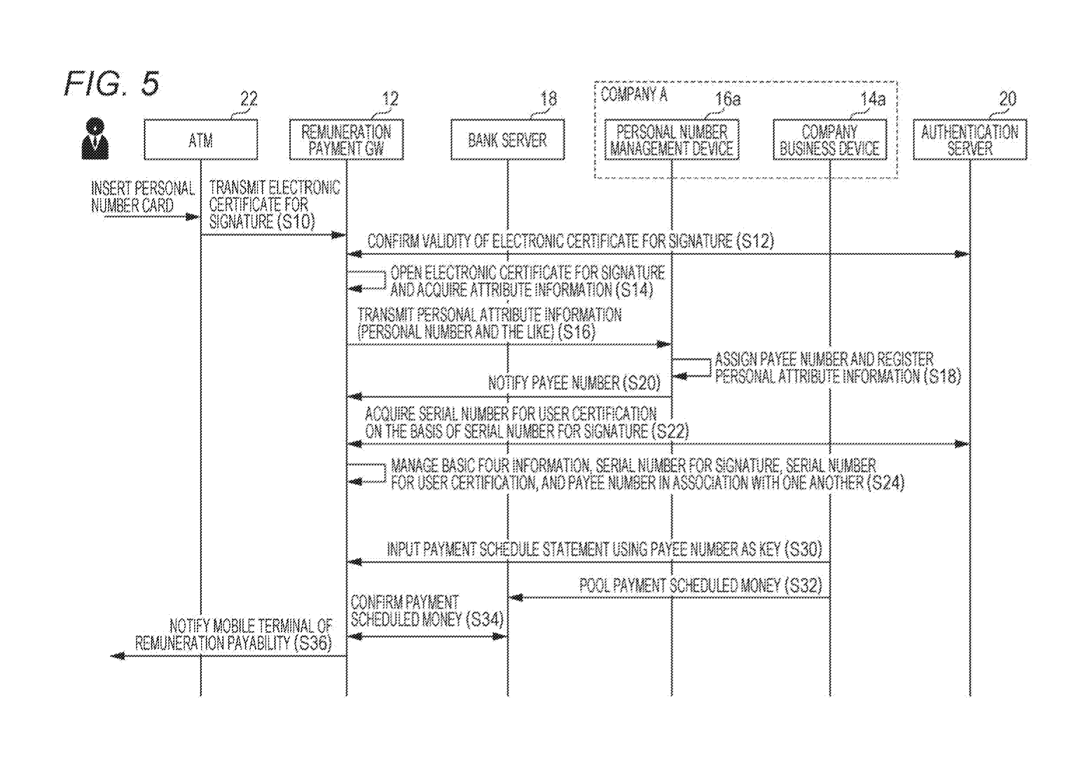

An operation of the remuneration payment system 10 with the above configuration will be described. FIG. 5 is a sequence diagram illustrating an operation of the remuneration payment system 10. In the sequence diagram of the present specification, description of the company B (the company business device 14b and the personal number management device 16b) is omitted for simplification of description. However, in reality, the devices of the company B executes similar processing to the devices (the company business device 14a and the personal number management device 16a) of the company A. As a premise, the individual enters into a contract stipulating that the individual provides a predetermined service to the company A and to the company B, and receives the remuneration using the remuneration payment system 10. Hereinafter, the individual is also called “remuneration recipient”.

S10 to S24 in FIG. 5 illustrate processing regarding user registration from the remuneration recipient to the remuneration payment GW 12. The remuneration recipient selects the user registration of the remuneration payment service on a menu screen of the ATM 22 and inserts the personal number card into the ATM 22. When the user registration of the remuneration payment service has been selected, the ATM 22 reads the data of the electronic certificate for signature from the personal number card. Then, the ATM 22 transmits the data of the electronic certificate for signature together with information indicating the user registration that is a selected menu to the remuneration payment GW 12 (S10).

When selection of the user registration of the remuneration payment service has been notified, the remuneration payment GW 12 executes subsequent processing. The personal data acquisition unit 61 of the remuneration payment GW 12 acquires the data of the electronic certificate for signature, and the validity confirmation unit 62 confirms validity of the electronic certificate for signature in cooperation with the authentication server 20 (S12). Here, it is assumed that the electronic certificate for signature has been confirmed valid. The personal attribute acquisition unit 63 of the remuneration payment GW 12 executes known open processing for the electronic certificate for signature, and extracts the four basic information, the personal number, and the serial number for signature of the remuneration recipient from the electronic certificate for signature (S14).

The personal number registration unit 64 of the remuneration payment GW 12 transmits the attribute information of the remuneration recipient including at least the personal number to the personal number management device 16a (S16). The personal number management device 16a assigns the company A payee number that is an ID for identifying the remuneration recipient by the company A, and records the company A payee number in association with the personal number of the remuneration recipient (S18). The personal number management device 16a notifies the remuneration payment GW 12 of the company A payee number of the remuneration recipient (S20). The personal number management device 16b not illustrated in FIG. 5 executes similar processing.

The personal attribute acquisition unit 63 of the remuneration payment GW 12 acquires the serial number for user certification of the remuneration recipient from the authentication server 20, using the serial number for signature acquired in S14 as a key (S22). As will be described below, the serial number for user certification of the remuneration recipient can be acquired from the personal number card of the remuneration recipient, but registration of an unauthorized serial number for user certification is prevented by acquiring the serial number for user certification from the authentication server 20. As illustrated in FIG. 4, the personal attribute recording unit 65 of the remuneration payment GW 12 stores the four basic information, the serial number for signature, the serial number for user certification, the company A payee number, and the company B payee number of the remuneration recipient to the personal attribute holding unit 56 in association with one another (S24).

S30 to S36 in FIG. 5 illustrates processing regarding notifying the remuneration recipient that reception of the remuneration is possible. The company business device 14a transmits the payment schedule statement in which the company A payee number of the remuneration recipient and the money payment amount to the remuneration recipient are written to the remuneration payment GW 12 (S30). In reality, the company business device 14a transmits a plurality of the payment schedule statements for money payment to a plurality of individuals to the remuneration payment GW 12. The company business device 14a transmits, to the bank server 18, data for depositing a payment scheduled money to the checking account of the company A (S32). The company business device 14b not illustrated in FIG. 5 executes similar processing. Note that deposit of the payment scheduled money to the checking account may be performed offline.

The deposit confirmation unit 67 of the remuneration payment GW 12 periodically accesses the bank server 18, and confirms whether the payment amount indicated by each payment schedule statement held in the payment schedule holding unit 57 has been deposited to the checking account of the company A and to the checking account of the company B (S34). When the payment amount indicated by the payment schedule statement addressed to the remuneration payer in the example in FIG. 5 has been deposited, the payability notification unit 68 of the remuneration payment GW 12 transmits a message notifying that reception of the remuneration is possible to an information terminal (a mobile phone or a smart phone) held by the remuneration payer (S36).

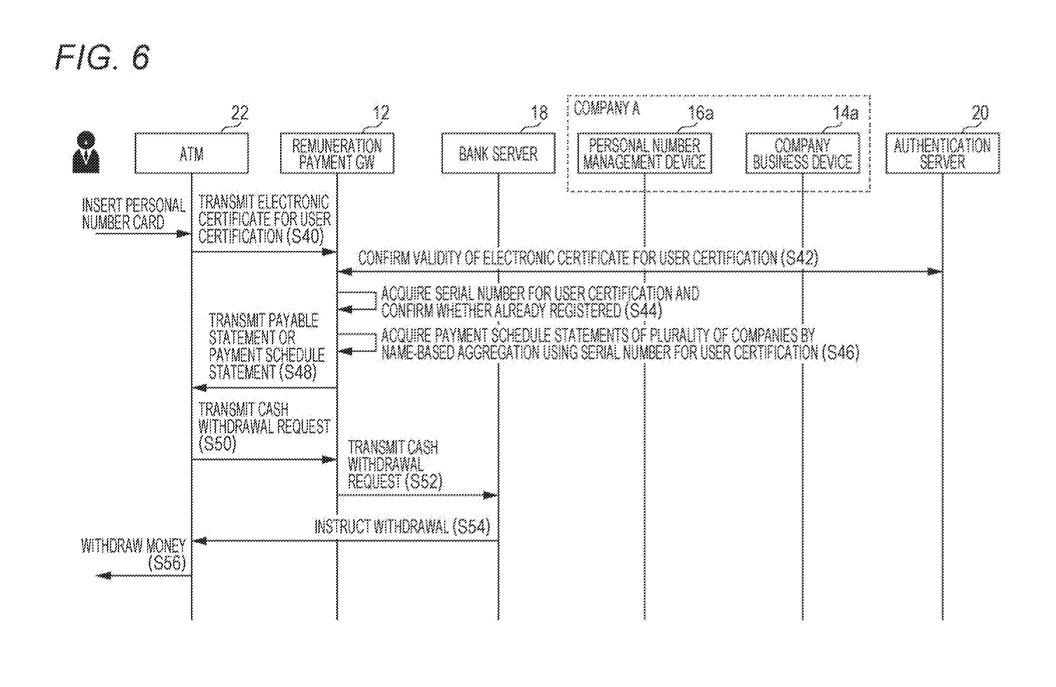

FIG. 6 is also a sequence diagram illustrating an operation of the remuneration payment system 10. FIG. 6 illustrates processing regarding payment of remuneration to the remuneration recipient. The remuneration recipient selects remuneration reception of the remuneration payment service on the menu screen of the ATM 22 and inserts the personal number card into the ATM 22. When the remuneration reception of the remuneration payment service has been selected, the ATM 22 reads the data of the electronic certificate for user certification from the personal number card. Then, the ATM 22 transmits the data of the electronic certificate for user certification together with information indicating the remuneration reception that is a selected menu to the remuneration payment GW 12 (S40).

When selection of the remuneration reception of the remuneration payment service has been notified, the remuneration payment GW 12 executes subsequent processing. The personal data acquisition unit 61 of the remuneration payment GW 12 acquires the data of the electronic certificate for user certification, and the validity confirmation unit 62 confirms validity of the electronic certificate for user certification in cooperation with the authentication server 20 (S42). Here, it is assumed that the electronic certificate for user certification has been confirmed valid.

The personal attribute acquisition unit 63 of the remuneration payment GW 12 executes open processing of the electronic certificate for user certification, and acquires the serial number for user certification of the remuneration recipient from the electronic certificate for user certification. The personal attribute acquisition unit 63 confirms whether the acquired serial number for user certification has been recorded in the personal attribute information in the personal attribute holding unit 56. That is, the personal attribute acquisition unit 63 confirms whether the remuneration recipient has been registered as a user of the remuneration payment service (S44). Here, it is assumed that the serial number for user certification has been registered.

The name-based aggregation processing unit 70 of the remuneration payment GW 12 identifies the company A payee number and the company B payee number of the remuneration recipient associated with the serial number for user certification of the remuneration recipient in the personal attribute information of the personal attribute holding unit 56. Then, the name-based aggregation processing unit 70 identifies one or more payment schedule statements associated with the identified company A payee number (the company A payment schedule statements), from among the payment schedule statements of the company A stored in the payment schedule holding unit 57. Similarly, the name-based aggregation processing unit 70 identifies one or more payment schedule statements associated with the identified company B payee number (the company B payment schedule statements), from among the payment schedule statements of the company B stored in the payment schedule holding unit 57 (S46).

The statement presenting unit 71 of the remuneration payment GW 12 transmits, to the ATM 22, a company A payability statement indicating a total payment amount of the statements to which the deposited flag has been set, in the company A payment schedule statement identified by the name-based aggregation processing unit 70, and the company A payment schedule statement indicating a total payment amount of the statements to which the deposited flag is not set, and causes the ATM 22 to display the statements on the screen of the ATM 22. Similarly, the statement presenting unit 71 transmits, to the ATM 22, the company B payability statement indicating the total payment amount of the statements to which the deposited flag has been set, in the company B payment schedule statement identified by the name-based aggregation processing unit 70, and the company B payment schedule statement indicating the total payment amount of the statements to which the deposited flag is not set, and causes the ATM 22 to display the statements on the screen of the ATM 22 (S48).

The remuneration recipient inputs an operation to request reception of the payment amount indicated by the company A payability statement (the payable amount from the company A) and the payment amount indicated by the company B payability statement (the payable amount from the company B) to the ATM 22. The ATM 22 transmits the cash withdrawal request specifying the company A payable amount and the cash withdrawal request specifying the company B payable amount to the remuneration payment GW 12 (S50). The payment execution unit 72 of the remuneration payment GW 12 transmits, to the bank server 18, a first cash withdrawal request requesting withdrawal of the company A payable amount from the checking account of the company A, and a second cash withdrawal request requesting withdrawal of the company B payable amount from the checking account of the company B (S52). The payment execution unit 72 generates the payment result statement on the basis of the payment schedule statement targeted for the cash withdrawal, and stores the payment result statement to the payment result holding unit 58. Note that, in the cash withdrawal request to be transmitted from the remuneration payment GW 12 to the bank server 18, an account number of each company, and identification information of the ATM 22 that is a place of withdrawal of the cash may be specified.

When the bank server 18 has received the first cash withdrawal request, the bank server 18 transmits, to the ATM 22, a withdrawal instruction that is data in a predetermined format for instructing withdrawal of the company A payable amount. Further, when the bank server 18 has received the second cash withdrawal request, the bank server 18 transmits, to the ATM 22, a withdrawal instruction instructing withdrawal of the company B payable amount (S54). This withdrawal instruction may be transferred to the ATM 22 via the remuneration payment GW 12. The bank server 18 subtracts the balance of the checking account of the company A by the company A payable amount (a withdrawn amount from the ATM 22), and also subtracts the balance of the checking account of the company B by the company B payable amount (a withdrawn amount from the ATM 22). The ATM 22 disburses the company A payable amount and the company B payable amount in response to the received withdrawal instructions (S56).

In this way, the individual who is the remuneration recipient can collectively receive the money paid by the plurality of companies, using his/her own personal number card, using the remuneration payment service provided by the remuneration payment GW 12. Further, after the user registration to the remuneration payment service, the information read from the personal number card at the payment of money is the electronic certificate for user certification, not the electronic certificate for signature including the personal number and the four basic information, and thus the risk of leakage of the important personal information can be reduced.

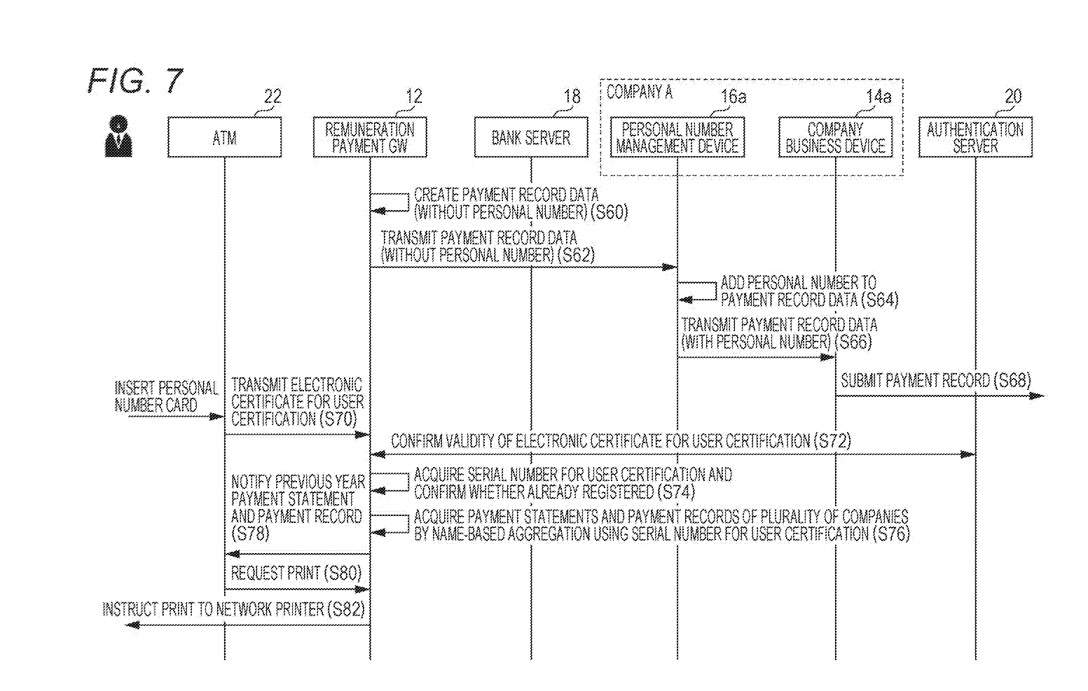

FIG. 7 is also a sequence diagram illustrating an operation of the remuneration payment system 10. S60 to S68 in FIG. 7 illustrates processing regarding provision of a payment record from the remuneration payment GW 12 to a company. When the record creating unit 73 of the remuneration payment GW 12 has detected that the time has reached the creation timing of the payment record data, the record creating unit 73 creates the payment record data not including the personal number of the remuneration recipient by reference to the payment result statement stored in the payment result holding unit 58 and the personal attribute information stored in the personal attribute holding unit 56, and stores the created data to the payment record holding unit 59 (S60). The record creating unit 73 creates a plurality of the payment records corresponding to a plurality of the payment result statements, and creates the payment record for each company.

When the record providing unit 74 of the remuneration payment GW 12 has detected that the time has reached the provision timing of the payment record data, the record providing unit 74 transmits the payment record data for the company A stored in the payment record holding unit 59 to the company A (here, to the personal number management device 16a) (S62). Although not illustrated in FIG. 7, the record providing unit 74 transmits the payment record data for the company B stored in the payment record holding unit 59 to the company B (personal number management device 16b).

The personal number management device 16a adds the personal number of the remuneration recipient registered in advance in S18 in FIG. 5 to the payment record data received from the remuneration payment GW 12 (S64). The personal number management device 16a transmits the payment record data to which the personal number has been set to the company business device 14a (S66). The company business device 14a submits the payment record to the administrative agency by transmitting the payment record data to which the personal number has been set to a device of the administrative agency (not illustrated, for example, a device of a tax office) (S68). Note that the processing of submitting the payment record from the company A to the administrative agency may be performed offline. In FIG. 7, processing of the company B (not illustrated) (the company business device 14b and the personal number management device 16b) is similar to that of the company A.

According to the remuneration payment GW 12 of the embodiment can support creation of the payment record to be submitted to the administrative agency by the company on the assumption that the disclosure destination (management entity) of the personal number is the company that is the remuneration payer. The company simply sets the personal number registered in advance to the payment record provided by the remuneration payment GW 12, and can drastically suppress the cost of the company for creation of the payment record creation.

S70 to S82 in FIG. 7 illustrates processing regarding provision of the payment record from the remuneration payment GW 12 to the remuneration recipient. The remuneration recipient (here, the individual who has received the remuneration from the company within this year) selects record creation of the remuneration payment service on the menu screen of the ATM 22 and inserts the personal number card into the ATM 22. When the record creation of the remuneration payment service has been selected, the ATM 22 reads the data of the electronic certificate for user certification from the personal number card. Then, the ATM 22 transmits the data of the electronic certificate for user certification together with information indicating the record creation that is a selected menu to the remuneration payment GW 12 (S70).

When selection of the record creation of the remuneration payment service has been notified, the remuneration payment GW 12 executes subsequent processing. The personal data acquisition unit 61 of the remuneration payment GW 12 acquires the data of the electronic certificate for user certification, and the validity confirmation unit 62 confirms validity of the electronic certificate for user certification in cooperation with the authentication server 20 (S72). Here, it is assumed that the electronic certificate for user certification has been confirmed valid. The personal attribute acquisition unit 63 of the remuneration payment GW 12 executes open processing of the electronic certificate for user certification, and acquires the serial number for user certification of the remuneration recipient from the electronic certificate for user certification. The personal attribute acquisition unit 63 confirms whether the acquired serial number for user certification has been recorded in the personal attribute information in the personal attribute holding unit 56 (S74). Here, it is assumed that the serial number for user certification has been registered.

The name-based aggregation processing unit 70 of the remuneration payment GW 12 identifies the company A payee number and the company B payee number of the remuneration recipient associated with the serial number for user certification of the remuneration recipient in the personal attribute information of the personal attribute holding unit 56. Then, the name-based aggregation processing unit 70 identifies one or more payment result statements associated with the identified company A payee number (called “the company A payment result statements”), from among the payment result statements of the company A stored in the payment result holding unit 58. Similarly, the name-based aggregation processing unit 70 identifies one or more payment result statements associated with the identified company B payee number (called “the company B payment result statements”), from among the payment result statements of the company B stored in the payment result holding unit 58 (S76).

Further, the name-based aggregation processing unit 70 identifies the payment record associated with the serial number for user certification of the remuneration recipient (called “the payment record”) acquired in S74 from among the payment records stored in the payment record holding unit 59 (S76). The record providing unit 74 of the remuneration payment GW 12 transmits the company A payment result statement, the company B payment result statement (these two statements can also be said to be “previous year payment statements”), and data of the payment record to the ATM 22, and causes the ATM 22 to display the data on the payment record screen (S78).

When the remuneration recipient inputs a print operation to the payment record screen, the ATM 22 transmits a print request of the previous year payment statements and the payment record to the remuneration payment GW 12 (S80). The record providing unit 74 of the remuneration payment GW 12 transmits the data of the previous year payment statements and the payment record to a predetermined network printer, and causes the network printer to print the previous year payment statements and the payment record (S82). For example, in the case where the remuneration recipient operates the ATM 22 installed in a convenience store, the record providing unit 74 may cause a network printer installed in the convenience store to print the data. Further, the record providing unit 74 may cause the printer 34 of the ATM 22 to print the data. The remuneration recipient writes his/her own personal number on the printed payment record, and submits the payment record after the personal number has been written to the tax office or the like.

According to the remuneration payment GW 12 of the embodiment, creation of the payment record to be submitted to the administrative agency by the individual as the remuneration recipient can be supported. The individual simply sets his/her own personal number to the payment record provided by the remuneration payment GW 12, and can drastically suppress the cost of the individual for the payment record creation.

The present invention has been described on the basis of the embodiment. The embodiment is an example, and it should be understood by those skilled in the art that various modifications can be made to combinations of the constituent elements and processing processes and that such modifications fall within the scope of the present invention. Hereinafter, modifications will be described.

Although not mentioned in the above embodiment, the remuneration payment GW 12 may manage existence or non-existence of money payment from each company to the individual, in other words, whether the remuneration recipient has received money, on a payment schedule statement basis acquired from the company A and the company B. In the present modification, a payment schedule statement transmitted from each of a company A and a company B to a remuneration payment GW 12 includes a statement number that is an ID determined in each company for uniquely specifying the payment schedule statement in the company, in addition to a payee number indicating an individual that is a remuneration recipient and a payment amount. Hereinafter, the statement number corresponding to the payment schedule statement from the company A is called “company A statement number”, the statement number corresponding to the payment schedule statement from the company B is called “company B statement number”.

When a payment schedule acquisition unit 66 of the remuneration payment GW 12 has acquired the payment schedule statement from a company business device 14a, the payment schedule acquisition unit 66 stores statement management information in which the company A statement number described in the payment schedule statement (or received together with the payment schedule statement) is associated with a company A payee number of the remuneration recipient to a personal attribute holding unit 56. Similarly, when the payment schedule acquisition unit 66 of the remuneration payment GW 12 has acquired the payment schedule statement from a company business device 14b, the payment schedule acquisition unit 66 stores statement management information in which the company B statement number described in the payment schedule statement is associated with a company B payee number of the remuneration recipient to the personal attribute holding unit 56. In the present modification, the personal attribute holding unit 56 further holds the statement management information as personal attribute information. However, storage means different from the personal attribute holding unit 56 may independently hold the statement management information.

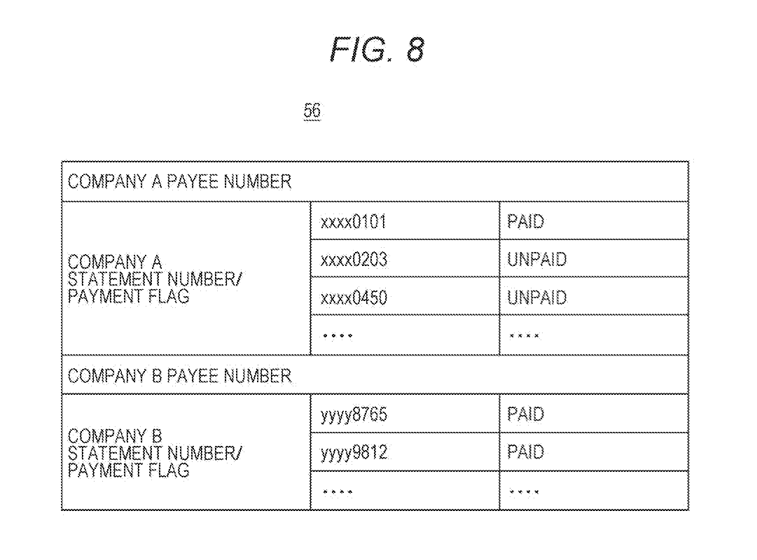

FIG. 8 illustrates an example of the statement management information held in the personal attribute holding unit 56. In the statement management information of the present embodiment, a payment flag is recorded in association with each of the company A statement number and the company B statement number. The payment flag is information indicating whether a payment amount indicated in the payment schedule statement has been paid, and FIG. 8 illustrates the payment flag by “paid” or “unpaid”. The payment schedule acquisition unit 66 sets “unpaid” as an initial value of the payment flag.

In the case where a money payment unit 69 (payment execution unit 72) of the remuneration payment GW 12 executes the above-described money payment processing to the remuneration recipient, the money payment unit 69 (payment execution unit 72) acquires the statement number indicated by the paid payment schedule statement, in other words, the statement number indicated by a payment result statement created on the basis of the paid payment schedule statement. Then, the payment flag associated with the statement number (the company A statement number or the company B statement number) in personal attribute information of a remuneration payer is updated to “paid”.

The money payment unit 69 of the remuneration payment GW 12 of the present modification further includes a payment management unit. The payment management unit periodically executes the following processing every time a predetermined period such as one week to one month, for example, a period specified by each of the company A and the company B passes. The payment management unit generates a payment state list for the company A and a payment state list for the company B by reference to each statement management information of each of a plurality of remuneration recipients held in the personal attribute holding unit 56. The payment management unit transmits the payment state list for the company A to the company business device 14a and the payment state list for the company B to the company business device 14b.

The payment management unit may generate list information (for example, the upper section in FIG. 8) in which each of company A payee numbers of the plurality of remuneration recipients is associated with a company A statement number and a payment flag, as the payment state list for the company A of the first aspect. Similarly, the payment management unit may generate list information (for example, the lower section in FIG. 8) in which each of company B payee numbers of the plurality of remuneration recipients is associated with a company B statement number and a payment flag, as the payment state list for the company B of the first aspect. Further, the payment management unit may generate list information in which each of the company A payee numbers of the plurality of remuneration recipients is associated with a company A statement number with an “unpaid” payment flag, as the payment state list for the company A of the second aspect. Similarly, the payment management unit may generate list information in which each of the company B payee numbers of the plurality of remuneration recipients is associated with a company B statement number with an “unpaid” payment flag, as the payment state list for the company B of the second aspect.

Further, the payment management unit may generate list information indicating a statement number of the payment schedule statement with an “unpaid” payment flag, and in which a predetermined period has passed from a payment date described in the payment schedule statement, as the payment state list of the third aspect, which is further narrowed down from the second aspect. This predetermined period may be two weeks to one month, or may be a period specified by each of the company A and the company B. According to the present modification, the company as the remuneration payer can easily grasp whether the individual as the remuneration payee has actually received the money. For example, the company as the remuneration payer can prompt the individual who has not received the remuneration even after the payment date of the remuneration has considerably passed to receive the remuneration.

Note that the remuneration payment GW 12 may assign the statement number in place of the company that issues the payment schedule statement. For example, the payment schedule acquisition unit 66 of the remuneration payment GW 12 may assign a company A statement number (can also be said to be a statement reception number) when having received a new payment schedule statement from the company business device 14a, and may assign a new company B statement number when having received a new payment schedule statement from the company business device 14b. The remuneration payment GW 12 may notify the newly assigned company A statement number to the company business device 14a in association with a file name of the payment schedule statement received from the company business device 14a. Similarly, the remuneration payment GW 12 may notify the newly assigned company B statement number to the company business device 14b in association with a file name of the payment schedule statement received from the company business device 14b. With this configuration, similar operation and effect as those of the above modifications can be obtained.

In the above-described embodiment, the information terminal for the remuneration recipient to access the remuneration payment GW 12 has been the ATM 22. However, the information terminal is not necessarily limited to the ATM. For example, the information terminal may be an information terminal other than the ATM, which has a function corresponding to the function illustrated in FIG. 2, or may be a kiosk terminal usable by public installed at the corner of a street or in a convenience store. Alternatively, the information terminal may be a PC installed at home of the remuneration recipient or the like.

In the case where the information terminal used by the remuneration recipient is a device (a PC or the like) from which cash cannot be withdrawn, the remuneration recipient may input an account number of his/her bank account to the information terminal as remuneration transfer information, and the information terminal may notify the remuneration transfer account number to the remuneration payment GW 12 in S50 in FIG. 6, for example. The money payment unit 69 of the remuneration payment GW 12 may execute processing for transferring the payment amount indicated by the payment schedule statement to the remuneration recipient received from the company A and the company B to the bank account of the remuneration recipient from checking accounts of the company A and the company B.

Any combination of the above-described embodiment and modifications is also useful as an embodiment of the present invention. A new embodiment resulting from the combination has both the effects of the combined embodiment and modification. Further, it should be understood by those skilled in the art that the functions to be fulfilled by the constituent elements described in the claims are realized by individual constituent elements or by cooperation of the constituent elements described in the embodiment and modifications.

The present invention can be applied to a device for assisting payment of money from a company to an individual.

What is claimed is:

1. An information processing apparatus connected with an information terminal operated by an individual and a company to pay money to the individual via a communication network, the information processing apparatus comprising:
a payment information acquisition unit configured to acquire, from the company, a plurality of pieces of payment information each indicating a payee ID indicating a payee of money and a payment amount of the money;
a personal data acquisition unit configured to acquire, from the information terminal, personal data read by the information terminal from a medium on which a personal number given to the individual by a public agency is recorded; and
a money payment unit configured to extract a plurality of pieces of the payment information indicating the payee ID according with an ID specified on the basis of the personal data acquired from the information terminal from among the plurality of pieces of payment information acquired by the payment information acquisition unit, and execute processing for paying a total amount of the payment amount indicated by the plurality of extracted pieces of payment information to the individual from an account opened in a financial institution by the company.

2. The information processing apparatus according to claim 1, connected with a first company and a second company to pay money to the individual, and further comprising:
an ID recording unit configured to record ID information in which a personal ID specified on the basis of the personal data acquired from the information terminal is associated with a first payee ID and a second payee ID, wherein
the first payee ID is an ID for identifying the individual as a payee of money determined by the first company, and the second payee ID is an ID for identifying the individual as a payee of money determined by the second company,
the payment information acquisition unit acquires pieces of the payment information from the first company and the second company, respectively, and
the money payment unit
identifies, from the ID information, the first payee ID and the second payee ID associated with the personal ID specified on the basis of the personal data acquired from the information terminal at payment of money to the individual,
identifies first payment information including the first payee ID and identifies second payment information including the second payee ID from among the pieces of payment information acquired by the payment information acquisition unit, and
executes processing for paying the payment amount indicated by the first payment information and the payment amount indicated by the second payment information to the individual.

3. The information processing apparatus according to claim 1 further comprising:
an ID recording unit, wherein
the personal data acquisition unit acquires an electronic certificate for signature of the individual from the information terminal, as the personal data, and acquires a serial number for user certification of the individual from a device of the public agency on the basis of the electronic certificate for signature, in a case where the individual inputs a first operation to the information terminal,
the ID recording unit records ID information in which the serial number for user certification is associated with a payee ID for identifying the individual as a payee of money determined by the company,
the payment information acquisition unit acquires the plurality of pieces of payment information from the company,
the personal data acquisition unit acquires an electronic certificate for user certification of the individual from the information terminal, as the personal data, in a case where the individual inputs a second operation to the information terminal, and
the money payment unit
identifies, with the ID information, the payee ID associated with the serial number for user certification extracted from the electronic certificate for user certification acquired from the information terminal, and
executes processing for paying the payment amount indicated by the payment information including the identified payee ID, of the plurality of pieces of payment information acquired by the payment information acquisition unit, to the person.

4. The information processing apparatus according to claim 1, further comprising:
a personal number registration unit configured to extract the personal number of the individual from an electronic certificate for signature of the individual acquired from the information terminal, and register the personal number to the company;
a record creating unit configured to create a payment record regarding payment of money to the individual and not including the personal number of the individual; and
a record providing unit configured to provide the payment record created by the record creating unit to the company, and cause the company to execute setting of the personal number of the individual to the payment record.

5. A money payment method in which an information processing apparatus connected with an information terminal operated by an individual and a company to pay money to the individual via a communication network execute the steps of:
acquiring, from the company, a plurality of pieces of payment information each indicating a payee ID indicating a payee of money and a payment amount of the money;
acquiring, from the information terminal, personal data read by the information terminal from a medium on which a personal number given to the individual by a public agency is recorded; and
extracting a plurality of pieces of the payment information indicating the payee ID according with an ID specified on the basis of the personal data acquired from the information terminal from among the plurality of pieces of payment information acquired from the company, and executing processing for paying a total amount of the payment amount indicated by the plurality of extracted pieces of payment information to the individual from an account opened in a financial institution by the company.

6. A computer program for causing an information processing apparatus connected with an information terminal operated by an individual and a company to pay money to the individual via a communication network to realize the functions of:
acquiring, from the company, a plurality of pieces of payment information each indicating a payee ID indicating a payee of money and a payment amount of the money;
acquiring, from the information terminal, personal data read by the information terminal from a medium on which a personal number given to the individual by a public agency is recorded; and
extracting a plurality of pieces of the payment information indicating the payee ID according with an ID specified on the basis of the personal data acquired from the information terminal from among the plurality of pieces of payment information acquired from the company, and executing processing for paying a total amount of the payment amount indicated by the plurality of extracted pieces of payment information to the individual from an account opened in a financial institution by the company.
